(19) United States
(12) Patent Application Publication
(10) Pub. No.: US 2014/0247348 A1
(43) Pub. Date: Sep. 4, 2014

(54) VIRTUAL RENT-A-CAR SYSTEM AND METHOD WITH IN-CAR CONCIERGE DEVICE

(71) Applicants: Robert D. Moore, JR., Oklahoma City, OK (US); Nicolas Oxley Johnson, New York, NY (US); Arnaud Lejeune, Paris (FR); Thierry Lucet, Paris (FR); Thierry Lemoult, Chelles (FR); Guillaume Remond, Paris (FR); Scott Alan Gaines, Wyckoff, NJ (US)

(72) Inventors: Robert D. Moore, JR., Oklahoma City, OK (US); Nicolas Oxley Johnson, New York, NY (US); Arnaud Lejeune, Paris (FR); Thierry Lucet, Paris (FR); Thierry Lemoult, Chelles (FR); Guillaume Remond, Paris (FR); Scott Alan Gaines, Wyckoff, NJ (US)

(73) Assignee: Hertz System, Inc., Park Ridge, NJ (US)

(21) Appl. No.: 13/782,608

(22) Filed: Mar. 1, 2013

(51) Int. Cl. G06Q 30/00; G01C 21/34; G06F 17/00; G06F 3/01

(52) U.S. Cl. CPC G06Q 30/016; G06F 3/017; G01C 21/34; G06F 17/00
USPC 348/148; 705/307; 709/219; 715/771; 370/338; 455/466; 701/468; 701/1; 701/36; 701/49; 701/2; 701/117

(57) ABSTRACT

A virtual rent-a-car system and method with an in-car device and related systems and methods are disclosed for providing customer service interactions, tools, and entertainment to a vehicle rental customer. The functions of the in-car device include, for example, navigational assistance, local recommendations, driving condition alerts, itinerary management, vehicle comfort controls, and entertainment media play controls.

### FIELD OF THE INVENTION

The present invention relates to a virtual rent-a-car (“vRAC”) system with an in-car device and related systems and methods of providing customer service interactions, tools, comfort, and entertainment to a vehicle rental customer.

### BACKGROUND OF THE INVENTION

A vehicle rental experience can present a number of challenges to the rental customer. For instance, one grows accustomed to the familiar controls, surroundings, and physical comforts of one's own car, and has to make certain adjustments when getting into a rental car for the first time. Thus, in any vehicle rental situation, climate control, seat position, mirror position, and steering wheel position typically take some time and effort to adjust as desired. When a vehicle rental takes place during travel away from home, as is often the case, many additional factors can further complicate the customer's rental experience, such as unfamiliarity with local roads and traffic patterns, local radio stations, and local entertainment and dining locations, as well as the need to manage a business and/or personal travel itinerary. On top of all of this, a customer may face unforeseen circumstances concerning the rental itself, such as the need to extend a rental period and/or report vehicle damage to the rental company.

A need therefore exists for a system and method of providing customer service interactions, tools, comfort, and entertainment to a vehicle rental customer to make the customer's rental experience simpler and more enjoyable.

### BRIEF SUMMARY OF THE INVENTION

In accordance with one aspect of the present invention, a system is provided for enhancing the convenience of a vehicle rental experience on a 24/7 basis. The system includes an in-car electronic device configured to be located in a rental vehicle and to receive and store input data remotely communicated to the device. For example, the input data may correspond to one or more of the rental customer's personal preferences or interests remotely communicated to the device, optionally prior to the beginning of a rental period, and the device may produce a message to the customer, determined by the stored preference data, when the customer is in the vehicle during the rental period.

In one embodiment, the device may have received data identifying a customer preference pertaining to one or more types of locations that that customer would be interested in visiting, such as natural historic landmarks, recreational facilities, coffee shops, scenic overlooks, hiking, running or bicycle paths, or museums, to name a few examples. The in-car device may comprise a GPS device, and the message may include information identifying one or more destination locations, corresponding to one or more location preference of the customer, and an estimated fastest route to the identified location from the current location of the vehicle. As desired, the message may identify the closest one of a particular type of location to the vehicle, or it may identify and list all locations of the particular type located within a predetermined distance from the vehicle.

In accordance with another aspect of the present invention, a system for enhancing the convenience of a vehicle rental experience includes an in-car device configured to be operatively connected to a rental vehicle and, when connected to the rental vehicle, to detect and control vehicle settings related to the physical environment within the vehicle itself. For example, the device may be configured to detect the state of a manually adjustable vehicle comfort setting and store input data corresponding to the state of the comfort setting, thus permitting a customer to adjust one or more settings to taste and then store the setting or settings in the memory of the device. Thus, advantageously, a repeat rental customer may enter a rental vehicle and input a command to an in-car device to restore one or more settings that the customer previously adjusted to taste and stored in an in-car device during a previous rental period. Alternatively, the settings may automatically be adjusted according to the customer's stored preference before the customer even enters the vehicle during the subsequent rental period, whether in response to a remotely transmitted command or by rental service personnel entering the vehicle and inputting the command. The command may be initiated, for example, by pressing a button or touching a screen icon on the device, by entering a code, by speaking a command word or phrase, by presenting or connecting a device, card, RFID signal, or image identifying a particular customer, or by remotely located rental service personnel or apparatus transmitting a signal to the in car device indicating that the rental period of a particular customer is beginning. Any type of comfort setting that can be accommodated by a vehicle mechanism or by the in-car device itself may be stored in and controlled by the device, including, for example, a thermostat temperature, a fan speed setting, a seat position, a seat warmer setting, a seat contour setting, a mirror position, a steering wheel position, a radio volume, and/or a type/genre of radio station or particular radio station frequency.

Where the comfort setting includes a seat position, the seat position may be determined by a plurality of different seat position parameters. For example, these may include a forward/rearward position, a seat bottom height, a head rest height, and/or a tilt angle of the entire seat structure or subpart thereof.

In one particular embodiment, the in-car device is configured to transmit stored comfort setting data to a remotely located server. During a subsequent rental period, the same or another in-car device, in the same or a different rental vehicle, is configured to download stored comfort setting data from the remotely located server, and to restore the stored settings either automatically or in response to one or more command prompts.

In still another aspect of the present invention, a system is provided for alerting a vehicle rental customer in a rental vehicle to a driving condition requiring an action by the customer. The system includes an in-car device configured to be located in the rental vehicle, the device configured to automatically receive information indicating the driving condition, to communicate a message indicating the driving condition to the customer, and to communicate a message to the customer indicating a suggested action to address the driving condition. The driving condition may be a vehicle condition, such as a fuel level, a battery charge level of an electric or hybrid electric vehicle, a fluid level, an engine temperature, a brake condition (e.g. caliper wear, fluid pressure), and a tire condition (e.g. tread wear, air pressure). For example, the device may indicate a low fuel or battery charge level and also identify the location of one or more fuel or charging stations near the vehicle. The device may also or alternatively be configured to identify and alert as to one or more environmental conditions, such as a traffic condition, a weather condition, and/or a road surface condition, and the corresponding message may include suggested directions for an alternate route to avoid encountering the environmental condition.

In accordance with still another aspect of the present invention, a system provides a mobile internet connection to a rental vehicle customer. The system includes an in-car device configured to be located in a rental vehicle, to connect to the internet wirelessly, and to permit a customer device to connect to the internet through a wired and/or wireless connection to the in-car device. Optionally, the in-car device may be configured to allow only one customer device to connect to the in-car device at the same time. As a still greater optional restriction, the in-car device may be configured to allow only one customer device to connect to the in-car device at any time during a rental period. Advantageously, the same in-car device may be configured to restrict the number of customer devices at a selected level or not at all, depending on an option selected by the customer, for a predetermined or negotiated price.

In accordance with yet another aspect of the present invention, a system provides an in-car wireless communication service to a vehicle rental customer. The system includes an in-car device configured to be located in a rental vehicle, to remotely receive data indicating a customer's preferred wireless communication service prior to a customer accessing the rental vehicle, and to permit the rental customer to send and receive text messages via the selected service. The preferred wireless communication service may for example be an SMS service associated with a mobile phone account of the customer. Alternatively, the wireless communication service may be an email service, the in-car device configured to remotely receive and store the customer's email address and login information, to log the customer in to the customer's email account during a rental period of the vehicle, and to automatically erase the customer's email address and login information from the memory of the device at the expiration of the rental period. Optionally, the in-car device may be configured to automatically log the customer in to the customer's email account when the customer turns on power to the vehicle, or in response to a customer input command. The in-car device may be configured to convert customer speech to text, to send a message comprising the converted text via the selected service. The device may also be configured to receive a text message via the selected service, to convert the received text message to simulated speech, and to read the text message to the customer as simulated speech.

In accordance with still another aspect of the present invention, a system is provided for real-time remote reporting of damage to a rental vehicle. The system includes an in-car device configured to be located in the rental vehicle, the in-car device configured to receive input from a user indicating damage to the vehicle and to automatically transmit the damage input to a remote server. Optionally, the in-car device comprises a camera and the user input comprises a digital photograph of the damage to the vehicle taken by the user.

Alternatively or additionally to facilitating damage reporting via a digital photograph, the in-car device may be configured to receive user input regarding damage through a touch screen. For example, the screen may display an image of the vehicle and sense a touch of a user at a location on the image corresponding to the location of the damage on the vehicle. In this embodiment, the user interface may further permit a user to specify a type of the damage (e.g. a bump/dent, a scratch/scrape, or a crack in mirror or window/windshield). For example, the user may touch an icon corresponding to one of the damage types, drag the icon to the location of the damage on the image, and release the icon.

### BRIEF DESCRIPTION OF THE DRAWINGS

FIG. 1 is a perspective view of a rental vehicle having an in-car electronic device according to the invention disposed therein.

FIG. 2 is a schematic representation of an in-car concierge system according to the invention.

FIG. 3 is a plan view of an in-car electronic device illustrating one embodiment of a graphical user interface according to the invention.

### DETAILED DESCRIPTION OF THE INVENTION

With reference to the accompanying Figures, in accordance with the present invention, an in-car electronic device, system and method for enhancing a vehicle rental experience are described in this section. The invention is particularly suitable for use within the context of a virtual rent-a-car system (“vRAC”) but may also be used with conventional car rental systems and methods. Likewise, a vRAC system is especially useful for short-term “on-demand” car rentals (e.g., by the hour) or car-sharing services, in which vehicles may be located at a variety of remote locations, but may also be used with conventional daily and weekly rentals, as is typical at airports and other locations.

In a vRAC, a customer creates a user profile with a car rental service. Preferably, the user profile is created online or by downloading an application (“app”) to the user's smartphone or other personal electronic device. The user profile includes personal information, vehicle preferences and payment information such as credit card data. The car rental service then sends the customer a vehicle access device, which may be in the form of a card or a fob for convenient attachment to a key chain. Once the customer has created his profile and obtained a vehicle access device, he may conveniently book a vehicle by reserving online or by using the application on his smartphone. The customer then proceeds to the vehicle location and swipes his vehicle access device over a reader (such as an RFID or other NFC device) located on the windshield or dashboard of the reserved vehicle, which will unlock the doors of the vehicle. The ignition key will be located within the vehicle, so the customer can then simply start the car and drive away. Once the customer is finished with the rental, he returns the car to a designated drop-off location, leaves the ignition key inside and locks the doors.

The in-car device provides utilitarian, personalization, customization and entertainment functionality to vehicle rental customers. In one aspect, the in-car device performs the traditional functions of a concierge, by automatically providing personalized information, recommendations, and navigational instructions pertaining to local business and personal destinations, based on information provided by the customer to the rental service prior to the rental period and uploaded to the in-car device according to the system and method of the invention. In addition, the in-car device In another aspect, the in-car device integrates the vehicle rental experience into a customer's digital life stream by enabling interactions that the customer is already used to in other contexts. The in-car device may also function as an intelligent comfort command module within a rental vehicle; a means for direct communications with the rental service; a touch-free speech-to-text and text-to-speech communication device adapted both for internet and for mobile telephone communication networks; and/or a mobile Wi-Fi internet “hot spot” providing connectivity to a customer device within the vehicle.

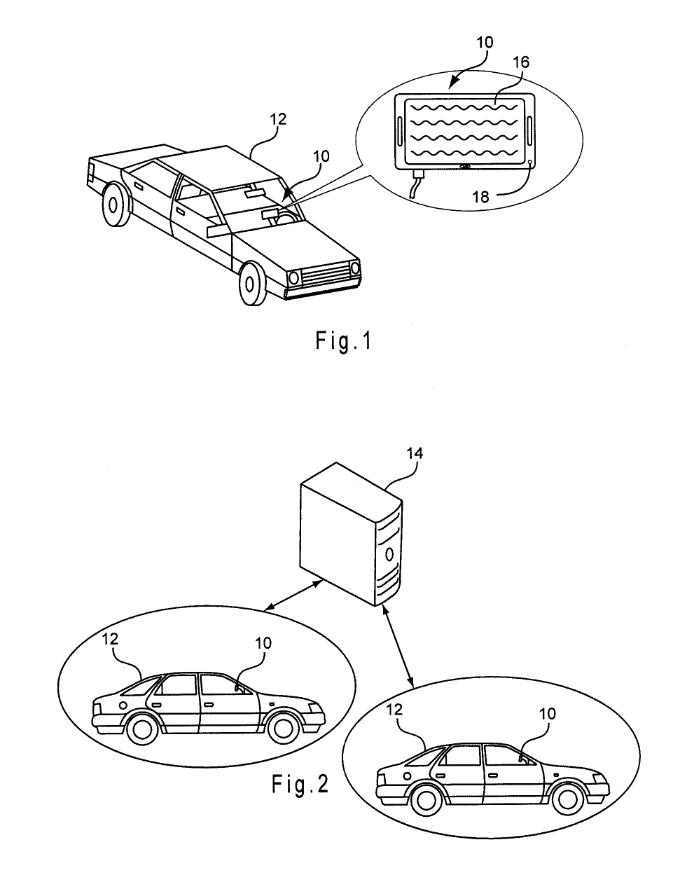

In particular, the system includes an in-car device 10 configured to be located inside a rental vehicle 12, as illustrated in FIG. 1. In-car device 10 is configured to send and receive data to and from a remote server 14 operated by a vehicle rental service, as depicted schematically in FIG. 2. Preferably, in-car device 10 is also configured to operatively connect to rental vehicle 12 to send and receive data signals to and from rental vehicle 12. In-car device 10 may be any suitable device of a size to be conveniently located inside vehicle 12, as long as the device includes a microprocessor; a memory; wireless communications connectivity; a graphical user display, which may be a touch screen 16, as shown in FIG. 1, or other suitable display screen; and a user input device or mechanism, which may for example be touch screen 16, a keypad (not shown), a touch pad separate from a display screen (not shown), and/or a microphone 18. In-car device 10 may be fully customized device, built solely for purposes of the system of the invention, or may be a custom-programmed mobile personal electronic device such as a mobile telephone, PC, or tablet, for example. It should be understood that the in-car device is not limited to a device that is affixed either permanently or detachably inside a vehicle, but also includes fully portable devices which may be used both within a vehicle and elsewhere. Where the portable device is a customer's personal electronic device such as a mobile smartphone, the device may be custom programmed by the user downloading a custom application (“app”) provided by a rental car service.

In one aspect of the invention, in-car device 10 is a personalized travel assistant. For instance, in-car device 10 may serve as a guide and navigational aid to local dining, entertainment, business offices, conference centers, and/or other destinations of interest. In this regard, in-car device 10 may provide a real-time visual overlay of ancillary information highlighting points of interest on a navigational map. Customer-provided preferences with regard to dining, entertainment, and other personal/discretionary travel destinations may be uploaded to device 10 in advance of the rental period, and device 10 may display and rank and/or recommend destinations based on how well they match the customer-provided preferences. Customer-supplied dining preferences may specify, for example, specific categories of dining, e.g. vegetarian/vegan, a specific type of meat or other food served, or a preferred national/ethnic/regional genre/style of cuisine, and device 10 may access internally or externally stored category information pertaining to restaurants in the local vicinity and then compare that information to the customer's category preferences. Similarly, with regard to entertainment and other points of interest, customer-preferred categories may include types of performance art; types of attractions such as historical, natural, cultural, architectural, amusement-park, or scientific; and/or types of activities such as sports, hiking, games, or gambling, and device 10 may display and rank and/or recommend local points of interest based on how well they match the customer's specified preferences. In a particular embodiment, device 10 may include a “guided tour” feature that provides streaming audio points-of-interest information pertaining to the present location of vehicle 12, as detected by the GPS component of device 10, and/or a recommended driving tour route visually indicated on a GPS map. The audio information conveyed and the driving tour routes recommended in accordance with the guided tour feature may or may not need to be limited by pre-specified customer preferences. This may depend, for example, on whether the particular locality offers a large enough number and variety of attractions visible from the same general stretch of road that it would be impossible to stream the audio describing each of them during the time in which each attraction is visible, such that it becomes helpful to filter the information based on the customer's personal tastes.

In accordance with another travel-assistant function, device 10 may store a customer itinerary and provide appropriate audio and/or visual alerts, alarms and reminders based on customer-supplied calendar and schedule information. This itinerary management feature may extend not only to scheduled activities occurring during the rental period, but also, for example, to an airline flight scheduled to follow the end of the rental period. In particular, based on customer-provided flight information, device 10 may provide the customer with real-time updates to flight on-time/delayed status, in addition to providing an interface for web-based online check-in, where available. The stored-itinerary feature of device 10 may also complement the navigational aid/destination recommender aspect of device 10, in that local destinations may be ranked and/or recommended based on the relative convenience of their locations with respect to the customer's required travel routes from each point on the itinerary to the next.

In another aspect of the travel assistant feature of device 10, device 10 provides real-time driving-condition alerts. These alerts can be related to at least three basic types of driving conditions: (1) forecast, remotely observed, or locally detected weather conditions; (2) traffic conditions, including reports of remotely observed heavy traffic or non-weather precursors of heavy traffic such as accidents, construction activity, or events expecting high attendance such as concerts, festivals or sporting events; and (3) conditions related to vehicle 12 itself, such as low fuel, low oil, low coolant/antifreeze, low transmission or brake fluid, low tire pressure, high engine temperature/overheating, a burned out external vehicle light bulb, or unusual vibration of a part of the vehicle.

In-car device 10 can also be adapted to serve as an intelligent comfort command module within vehicle 12. In this regard, device 10 may input and internally or externally store information pertaining to a “comfort setting” such as a customer's preferred seat position, cabin temperature, radio format, etc., and later access that information to restore a “comfort setting” to the customer's preferred state. For example, a customer may first manually adjust a seat position in rental vehicle 12 to a preferred position and direct device 10 to “remember” the seat position, such as either by a voice command or by a touch or series of touches on screen 16. Then, after the rental period has expired, the next time the customer returns to rental vehicle 12, or any other rental vehicle having analogous seat position controls, the customer will not have to rediscover the most comfortable seat position by trial and error, typically involving the manipulation of multiple parameters such as seat height, seat forward/backward location, and seat tilt, the latter of which may even include a separate tilt control for the seat bottom and seat back. Instead, the customer may simply instruct the in car device 10 to cause the seat position to return to its stored state. In accordance with this feature, in-car device 10 is operatively connected to rental vehicle 12 to detect the state of each applicable comfort setting and to direct vehicle 12 to return the comfort setting to a stored state.

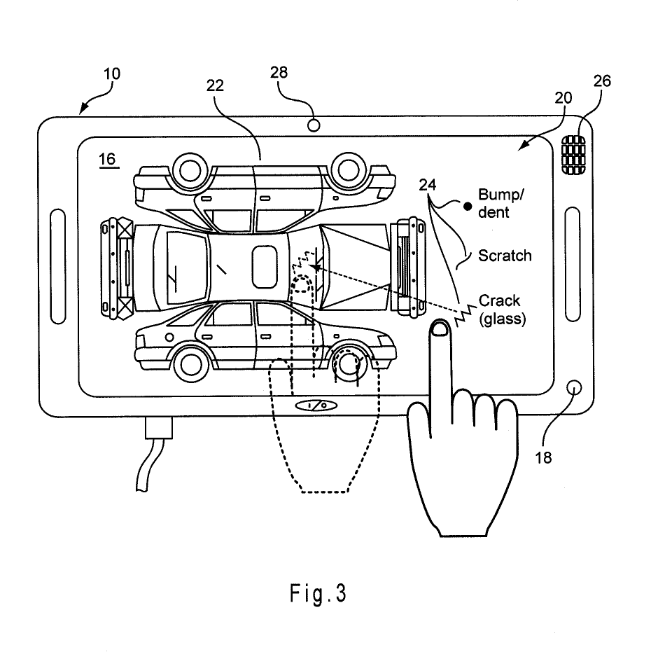

In-car device 10 can also provide a direct communications link to the rental service. For instance, in-car device 10 may provide for real-time remote reporting of damage to vehicle 12. To this end, touch screen 16 of in-car device 10 may be configured to receive a digital photographic image of the damage, either via a USB or Bluetooth® connection to a customer digital camera device, or by downloading an image captured by a customer digital camera device and uploaded to the internet. Alternatively, in-car device 10 may be removable from rental vehicle 12 and may itself serve as a digital camera device for directly capturing an image of the damage. In either case, in-car device 10 is then configured to upload the received/captured image file to the vehicle rental service so that it may take note of the damage. In another embodiment, in-car device 10 is configured to display a damage-reporting graphical user interface, which may for example resemble damage-reporting GUI 20 depicted in FIG. 3. In GUI 20, a two-dimensional image 22 of vehicle 12 is displayed on touch screen 16, and damage-type markers 24 are displayed on touch screen 16 away from 2-D vehicle image 22. To indicate damage of a certain type at a certain location on rental vehicle 12, a customer may simply touch the appropriate damage-type marker 24 and drag marker 24 to the location of the damage on vehicle image 22, simply touch the damage location on vehicle image 12 before or after touching the appropriate marker 24, or perform any other intuitive sequence of steps. Although 2-D vehicle image 22 is depicted as an “unfolded” or “flattened” image showing all sides of the vehicle body in a single plane, separate planar views approximating actual elevation and plan views of the vehicle body may be used as desired, either together in a single frame or in separate views that can be selectively made to appear on screen 16 by a swipe or other input.

Should a rental customer wish to transact with the vehicle rental service from inside the vehicle during a rental, various features of in-car device 10 may be provided to facilitate such transactions. For example, in-car device 10 may display on touch screen 16 a graphical user interface permitting a customer to modify, extend, or request to modify or extend a rental contract by simply inputting instructions via touch screen 16, without the customer having to wait for an available agent. In-car device 10 may also provide a video display of a live customer service agent on touch screen 16 for live customer service interactions. Microphone 18 and a speaker 26 facilitate audio customer service interactions, and optionally, a camera 28 may also be included in in-car device 10 for two-way video chat capability between the customer and the customer service agent.

In-car device 10 may also provide other communication functions personalized to the rental customer. In accordance with this aspect, at the time of the reservation and before the start of the rental period, the rental customer is given the option to specify to the rental service any desired communication service to which the rental customer would like to have access in rental vehicle 12, via device 10, during the rental period. For example, the rental customer may specify a mobile phone service provider and/or her mobile phone number, her email service provider, and any professional or social networking websites which she would like to be able to access via device 10. Based on the rental customer's stated preferences, the rental service provider remotely submits instructions to device 10 to enable use of device 10 for each desired service, either automatically at the start of the rental period, or upon input by the rental customer of a password or other secret information into the device, as prompted by the device. Where device 10 is enabled for use with professional and/or social networking sites, device 10 may be configured to upload photos, videos or other electronic files or data to the sites. In the case of using device 10 for mobile phone communications, device 10 may be adapted both to receive calls directed to the rental customer's mobile phone number and to place calls from the rental customer's mobile phone number, either through a wired or Bluetooth® connection to the rental customer's phone or by way of a call-forwarding arrangement with the rental customer's mobile phone service provider not requiring a direct connection of device 10 to the rental customer's phone.

Device 10 may further be adapted for text-to-speech and speech-to-text functionality in connection with any enabled mode of communication. For example, without limitation, device 10 may be adapted to receive speech input from a rental customer via microphone 18, to convert the speech input into text, and conversely, to convert text input received remotely via any enabled communication service into speech output through speaker 26, whether the sent or received text corresponds to the text of an SMS or other type of mobile phone text message, an email, an electronic message, posting, or notification sent via a professional or social networking website, or any other type of remote electronic textual message. Device 10 may also perform text-to-speech reading of customer-subscribed RSS feeds, which may be specified by the customer before the rental period and remotely uploaded to device 10 by the rental service provider.

In-car device 10 may also display an itemized receipt, including a base rental fee and any other charges, such as fuel and toll charges, for example. In this regard, in-car device 10 is advantageously operatively connected to rental vehicle 12 so as to detect the fuel level in vehicle 12, represented as a fraction of a tank or a mileage remaining, or in the case of an electric or hybrid-electric vehicle, the percent battery charge and/or battery mileage remaining. With regard to toll charges, in-car device 10 may either itself include or be operatively connected to an electronic toll transponder for automatic tolling.

In-car device 10 can further serve as a “mobile hotspot” for in-car wireless internet connectivity such as Wi-Fi® connectivity. In accordance with this feature, a single customer device is typically permitted to access the internet through in-car device 10 at any one time, for the duration of a rental period. Thus, a single customer IP address of the customer device is typically associated with in-car device 10. Optionally, depending on bandwidth availability and telecommunications cost considerations, it may be desirable to configure in-car device 10 to permit customers to connect more than one device at one time. Alternatively, more than one customer IP address, corresponding to multiple customer devices, may be associated with in-car device 10 for connection of any one of the devices at any given time during the rental period, to provide the customer with flexible Wi-Fi® use options while preserving bandwidth.

In-car device 10 may additionally serve as an in-car entertainment console. In accordance with this aspect, in-car device 10 may include a control interface, typically a graphical user interface displayed on touch screen 16, for playing live or recorded media inside rental vehicle 12. For DVD media playback in-car device 10 optionally includes controls for rear (or front when stationary) display of DVD video content. For this function, in-car device 10 will utilize its GPS functionality and/or its operative connection to a vehicle wheel-position sensor of rental vehicle 12 to sense whether rental vehicle 12 is in motion, and if rental vehicle 12 is not in motion, in-car device 10 will permit front display of DVD video content. Alternatively, front display may be prohibited when a drive gear of rental vehicle 12 is engaged, even if rental vehicle 12 is stationary. Similar functionality may be provided for display of still images, for example via a mini USB connection of in-car device 10 to a digital camera, with similar restrictions on front display. Likewise, in-car device 10 may provide controls for live audio play, for example via conventional or satellite radio, or recorded audio playback, for example of downloadable audio, such as a podcast, or of audio from a user device via a ¼ ″ headphone jack or Apple iPod® music interface.

If the customer is using a personal electronic device, the rental car service may communicate with the customer prior to, during and after the rental. For example, if the customer is picking up a car at an airport, when making his reservation he may provide flight information. Upon the flight's arrival at the airport, the car rental service sends a message (e.g., an SMS text message and/or email to the customer informing him of his rental car details, including the car that was assigned to him as well as the stall number where the car is located. The customer may also be given the opportunity to change or upgrade the car that was assigned to him. Some customers might not prefer the exact make and/or model of vehicle assigned to them, or their travel plans might have changed and they need a different or larger vehicle. Upon receiving the message, the customer may swap out a pre-assigned car for a similar car for no additional charge. The customer may also take advantage of a special “deal of the day” promotion and/or upgrade to different car for an additional charge. Preferably, the swap/upgrade function is simple and can be completed in as few as three clicks on the customer's device. Customers are not required to interact with a rental agent to make a change. They simply change their car choice and are given directions to that new vehicle. Preferably, the customer's upgrade choices are presented in a protected manner, so that he has a short period of time to select a different vehicle without fear that it will not be available when he makes his choice. The invention provides a convenient way to make a change without the inconvenience or delay that might be required to deal with a rental agent. After the rental is completed, the rental car service can send to the customer's device additional information such as a thank-you message, copy of a receipt, customer satisfaction survey, promotional offer or the like.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A system for enhancing the convenience of a vehicle rental experience comprising:
an in-car device configured to be located in a rental vehicle and configured to receive and store input data remotely communicated to the in-car device, the input data corresponding to a rental customer preference, and to produce a message determined by the stored preference data, the message perceptible to a rental customer in the vehicle.

2. The system of claim 1,
the in-car device comprising a GPS device,
the input data including data remotely communicated to the in-car device, identifying a customer location preference, and
the message including information identifying a location corresponding to the location preference and an estimated fastest route to the identified location from the current location of the vehicle.

3. The system of claim 2,
the input data including data corresponding to a category of locations preferred by the customer,
the in-car device configured to find a location in a database that is within the preferred category, and
the message including information identifying the found location in the preferred category if the found location is currently within a predetermined distance from the vehicle.

4. A system for enhancing the convenience of a vehicle rental experience comprising:
an in-car device configured to be operatively connected to a rental vehicle and, when connected to the rental vehicle, to detect a state of a manually adjustable vehicle comfort setting and store input data corresponding to the state of the comfort setting, and to cause the comfort setting to adjust to a stored state corresponding to the stored input data.

5. The system of claim 4, the comfort setting selected from the group consisting of a thermostat temperature, a fan setting, a seat position, a seat warmer setting, a seat contour setting, a mirror position, a steering wheel position, a radio volume, and a radio station frequency.

6. The system of claim 5, the comfort setting including a seat position determined by a plurality of seat position parameters.

7. The system of claim 6, the seat position parameters including a forward-rearward seat position, a seat height, and a seat tilt.

8. The system of claim 4, the in-car device configured to transmit stored comfort setting data to a remotely located server and to download stored comfort setting data from the remotely located server.

9. The system of claim 8, wherein the in-car device is a first in-car device configured to be operatively connected to a first rental vehicle, further comprising a second in-car device configured to be operatively connected to a second rental vehicle, to download comfort setting data transmitted to the remotely located server by the first in-car device and, when connected to the second rental vehicle, to cause a comfort setting of the second rental vehicle to automatically adjust to the stored state.

10. A system for alerting a vehicle rental customer in a rental vehicle to a driving condition requiring an action by the customer, comprising
an in-car device configured to be located in the rental vehicle, the device configured to automatically receive information indicating the driving condition and to communicate a message indicating the driving condition to the customer.

11. The system of claim 10, the driving condition being a vehicle condition.

12. The system of claim 11, the vehicle condition selected from a group consisting of a fuel level, a battery charge level, a fluid level, an engine temperature, a brake wear condition, and a tire pressure.

13. The system of claim 12, the message indicating a low fuel level and identifying a location of a fuel station near the vehicle.

14. The system of claim 10, the driving condition being an environmental condition selected from the group consisting of a traffic condition, a weather condition, and a road surface condition.

15. The system of claim 14, the message including suggested directions for an alternate route to avoid encountering the environmental condition.

16. A system for providing a mobile internet connection to a rental vehicle customer comprising:
an in-car device configured to be located in a rental vehicle, the in-car device configured to connect to the internet wirelessly and to permit a customer device to connect to the internet by connecting to the in-car device.

17. The system of claim 16, the in-car device configured to emit a wireless internet signal to permit the customer device to connect to the internet by connecting wirelessly to the in-car device.

18. The system of claim 16, the in-car device configured to allow only one customer device to connect to the in-car device at a time.

19. The system of claim 16, the in-car device configured to allow only one customer device to connect to the in-car device at any time during a rental period.

20. A system for providing an in-car wireless communication service to a vehicle rental customer comprising
an in-car device configured to be located in a rental vehicle, to remotely receive data indicating a customer's preferred wireless communication service prior to a customer accessing the rental vehicle, and to permit the rental customer to send and receive text messages via the selected service.

21. The system of claim 20, the wireless communication service being an SMS service associated with a mobile phone account of the customer.

22. The system of claim 20, the wireless communication service being an email service, the in-car device configured to remotely receive and store the customer's email address and login information, to log the customer in to the customer's email account during a rental period of the vehicle, and to automatically erase the customer's email address and login information from the device at the expiration of the rental period.

23. The system of claim 22, the in-car device configured to automatically log the customer in to the customer's email account when the customer turns on power to the vehicle.

24. The system of claim 22, the in-car device configured to log the customer in to the customer's email account in response to a customer input command.

25. The system of claim 20, the in-car device configured to convert customer speech to text, to send a message comprising the converted text via the selected service, to receive a text message via the selected service, to convert the received text message to simulated speech, and to read the text message to the customer as simulated speech.

26. A system for real-time remote reporting of damage to a rental vehicle comprising
an in-car device configured to be located in the rental vehicle, the in-car device configured to receive input from a user indicating damage to the vehicle and to automatically transmit the damage input to a remote server.

27. The system of claim 26, the in-car device comprising a camera and the user input comprising a digital photograph of the damage to the vehicle taken by the user.

28. The system of claim 26, the in-car device configured to display an image of the vehicle on a touch screen and to sense a touch of a user on the touch screen at a location on the image of the vehicle corresponding to the location of the damage on the vehicle.

29. The system of claim 28, the in-car device configured to permit a user to specify a type of the damage by touching an area of the screen indicating the damage type.

30. The system of claim 29, the in-car device configured to display a plurality of damage-type markers, each marker indicating a different type of vehicle damage, and to permit a user to touch the image of a particular marker on the screen and drag the image to a location on the vehicle image to indicate a location on the vehicle of damage of a type corresponding to the marker.

31. A virtual car rental system comprising:
a vehicle access device having memory for storing customer data;
a reader mounted on a vehicle for wirelessly reading data from the vehicle access device;
means for automatically unlocking the doors of the vehicle in response to a signal from the reader; and
a device configured for use in the vehicle and configured to be operatively connected to the vehicle.

32. A virtual car rental method comprising:
sending to a customer's personal electronic device a message containing rental vehicle information, wherein the message further contains one or more offers for an alternate vehicle;
receiving from the customer's personal electronic device a response to the one or more offers;
modifying the rental vehicle information based on the response if the customer has accepted one of the offers; and
sending to the customer's personal electronic device a message containing the modified rental vehicle information.
